(19) United States
(12) Patent Application Publication
(10) Pub. No.: US 2004/0238623 A1
(43) Pub. Date: Dec. 2, 2004

(54) Component handling device having a film insert molded RFID tag

(76) Inventor: Wayne Asp, Waconia, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/839,803

(22) Filed: May 5, 2004

Related U.S. Application Data
(60) Provisional application No. 60/469,158, filed on May 9, 2003.

(51) Int. Cl. G06K 5/00

(52) U.S. Cl. 235/380; 340/572.8; 235/491

(57) ABSTRACT

A system and method for including a thin and flexible RFID tag in the molding process for handlers, transporters, carriers, trays and like handling devices utilized in the semiconductor and sensitive electronic component processing and handling industries. The RFID tag of predetermined size and shape is generally bonded or encapsulated between two thermopolymer film layers to create an RFID tag laminate. This RFID tag laminate is selectively placed along a shaping surface in a mold cavity for alignment with a desired target surface of a moldable molten resin material such that upon completion of the film insert molding process, the RFID tag laminate is integrally bonded to at least a portion of the molded handling device, or handling device component/part.

### RELATED APPLICATIONS

The present application claims the benefit of U.S. Provisional Application No. 60/469,158, filed May 9, 2003, and entitled “COMPONENT HANDLING DEVICE HAVING A FILM INSERT MOLDED RFID TAG,” which is hereby incorporated in its entirety by reference.

### FIELD OF THE INVENTION

The present invention relates generally to film insert molding, and more particularly to insert molding a thin flexible Radio Frequency Identification (“RFID”) tag laminate during the molding of component handling devices.

### BACKGROUND OF THE INVENTION

Conventional film insert molding techniques are generally utilized in manufacturing processes to increase aesthetic appeal in various consumer products. Namely, decorative decals, instructions, logos, and other visual graphics are printed on one surface of a thin transparent polymer film for use in the insert molding process. In these circumstances the film is placed into a portion of the mold prior to the injection of the moldable material. This creates a bond between the film and the molded part such that inexpensive decoration or indicia can be selectively placed on the part, while at the same time simplifying the use of indicia around complicated contours and in difficult-to-reach locations. Similarly, such film insert molding or decorative molding simplifies the manufacturing process by eliminating the need to have the indicia etched or shaped into the actual surface of the mold itself. This increases design and manufacturing flexibility, and the level of detail that can be included in the final product.

The semiconductor industry introduces unique and unconventional purity and anti-contamination requirements into the development and implementation of product designs and manufacturing processes. Most importantly, material selection is essential in the manufacturing, storage, and transportation of components and assemblies. For instance, various polymer materials such as polyethylene (PE), polycarbonates (PC), perflueroalkoxy (PFA), polyetheretherketone (PEEK), and the like are generally utilized in the manufacturing of components and structures incorporated in constructing wafer carriers, chip trays, hard disk carriers, and other device handlers.

The processing of wafer disks, chips, hard disks, and other sensitive components often involves several steps where the components are repeatedly processed, stored and transported. Due to the delicate nature of the components and their extreme value, it is vital that they are properly protected throughout this procedure. One purpose of a sensitive component handling device is to provide this protection. There are a number of material characteristics which are useful and advantageous for handling devices depending on the type of handler and the particular part thereof.

During processing of wafers, chips, and/or hard disks, the presence or generation of particulates presents very significant contamination problems. Contamination is accepted as the single largest cause of yield loss in the semiconductor industry. As the size of integrated circuitry and other devices has continued to be reduced, the size of particles which can contaminate an integrated circuit or other components has also become smaller, making minimization of contaminants all the more critical. U.S. Pat. No. 5,780,127 discusses various characteristics of plastics which are pertinent to the suitability of such materials for wafer carriers, and is incorporated herein by reference.

Other important characteristics for device handlers include the cost of the material and the ease of molding the material. These device handlers are typically formed of injection molded plastics such as PC, acrylonitrile butadiene styrene (ABS), polypropylene (PP), PE, PFA, PEEK, and like materials. Typical inexpensive conventional plastics release tiny particles into the air when abraded or even when rubbed against other material or objects. While these particles are typically invisible to the naked eye, they result in the introduction of potentially damaging contaminants that may adhere to semiconductor components being processed, and into the necessarily controlled environments. However, specialized thermoplastic polymers are dramatically more expensive than conventional polymers. In fact, the various specialized thermoplastic polymers themselves can vary greatly—i.e., PEEK is more expensive than PC.

Implementation or integration of inventory control devices, such as Radio Frequency Identification (“RFID”) tags, are utilized in the manufacturing and processing of these sensitive components to track production stages, produced components, component locations and the like. However, as stated, the highly sensitive and contaminant-sensitive nature of the environment for processing semiconductor wafers, hard disks, chips, and other components limits the practical use of such devices. Limitations on the use of various adhesives to adhere the tags directly to the handling devices, and the exposure of these tags and their resulting particulates to the sensitive processing and manufacturing environments is problematic. Conventional attempts to integrate RFID tags in the industry has consisted of directly joining the tags to a recess in the handler and then covering the tags with another handler component part to provide isolation and protection. U.S. Pat. Nos. 4,827,110 and 6,164,530 teach such conventional techniques, and are incorporated herein by reference. However, these conventional techniques of providing an RFID tag with such handling devices often require additional expensive thermopolymer materials, and altered handler device designs, thereby adding to the manufacturing costs, and introducing additional component complexity which can potentially jeopardize the functionality and aesthetic appeal of the handlers.

As a result, there is a need for manufacturing techniques that substantially reduce unnecessary manufacturing processes and component complexity while simultaneously permitting targeted implementation of RFID tags to provide identification and inventory control of handling devices and their contents.

### SUMMARY OF THE INVENTION

The present invention relates generally to a system and method for including a thin and flexible RFID tag in the molding process for handlers, transporters, carriers, trays and like handling devices utilized in the semiconductor and sensitive electronic component processing industries. The RFID tag of predetermined size and shape is generally bonded or encapsulated between two thermopolymer film layers to create an RFID tag laminate. This RFID tag laminate is then selectively placed along a shaping surface in a mold cavity for alignment with a desired target surface of a moldable molten resin material. The molding process causes a surface of one of the two film layers to bond to a contact surface of the moldable material such that the RFID tag laminate is permanently and integrally bonded to the moldable material. The protective film layer designated for bonding to the moldable material is preferably constructed of a thermopolymer, such as polycarbonate, polypropylene, PEEK, or PEI. Other compatible materials can also be employed which will withstand, or at least provide a protective barrier from, the high temperatures associated with the molding process.

An object and feature of certain embodiments of the present invention is that it provides a cost-efficient method of selectively utilizing desirable RFID tags at target surface locations without altering the design and material configuration of the sensitive component handling devices.

Another object and feature of certain embodiments of the present invention is that a protective film can be included to provide a barrier of protection from the heat generated during the molding process of the target surface of the handling device.

Yet another object and feature of certain embodiments of the present invention is that the protective film can be included to provide an abrasion-resistant layer of protection.

Still another object and feature of certain embodiments of the present invention is including graphical or other indicia on at least one of the film layers comprising the RFID tag laminate to substantially disguise or hide the RFID flex circuit encapsulated therein, or to provide desirable product, company, or like aesthetic graphics.

A further object and feature of certain embodiments of the present invention involves including perforations or other forms of escape passageways out at least one layer of the laminate to promote evacuation of gasses, such that air pocketing/bubbling is avoided.

### BRIEF DESCRIPTION OF THE DRAWINGS

FIG. 1 is a side cross-sectional view of an RFID tag laminate bonded to a handling device in accordance with an embodiment of the present invention.

FIG. 2 is a side cross-sectional view of an RFID tag laminate bonded to a handling device in accordance with an embodiment of the present invention.

FIG. 3 is a side cross-sectional view of an RFID tag laminate bonded to a handling device in accordance with an embodiment of the present invention.

FIG. 4 is a side cross-sectional view of an RFID tag laminate bonded to a handling device in accordance with an embodiment of the present invention.

FIG. 5a is a perspective view of an RFID tag laminate bonded to a carrier handling device in accordance with an embodiment of the present invention.

FIG. 5b is a perspective view of an RFID tag laminate bonded to a carrier handling device in accordance with an embodiment of the present invention.

FIG. 5c is a perspective view of an RFID tag laminate bonded to a chip tray handling device in accordance with an embodiment of the present invention.

FIG. 6 is a side cross-sectional view of an RFID tag laminate film insert molding system in accordance with an embodiment of the present invention.

FIG. 7 is a side cross-sectional view of a portion of the RFID tag laminate film insert molding system of FIG. 6.

FIG. 8 is a side cross-sectional view of an RFID tag laminate film insert molding system in accordance with an embodiment of the present invention.

### DETAILED DESCRIPTION OF THE DRAWINGS

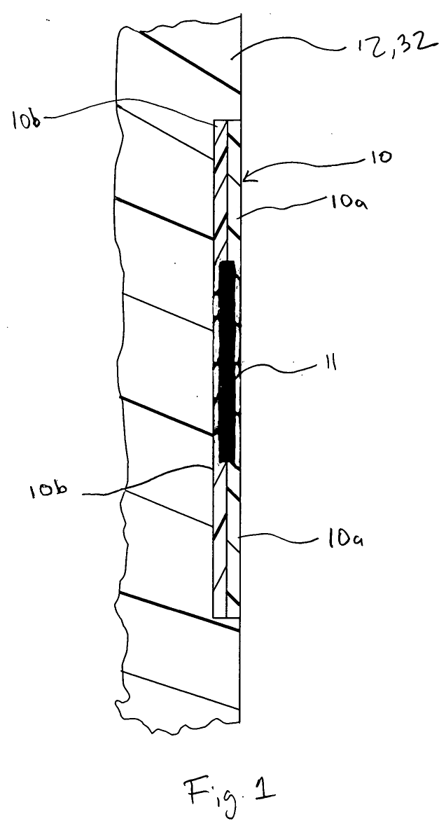

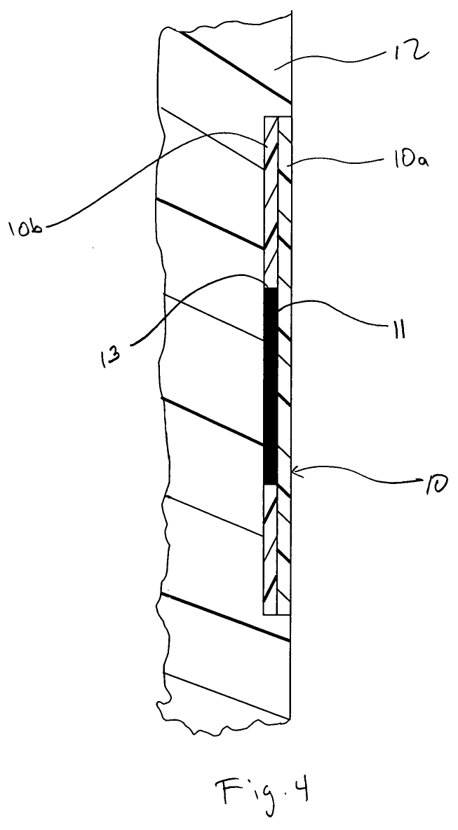

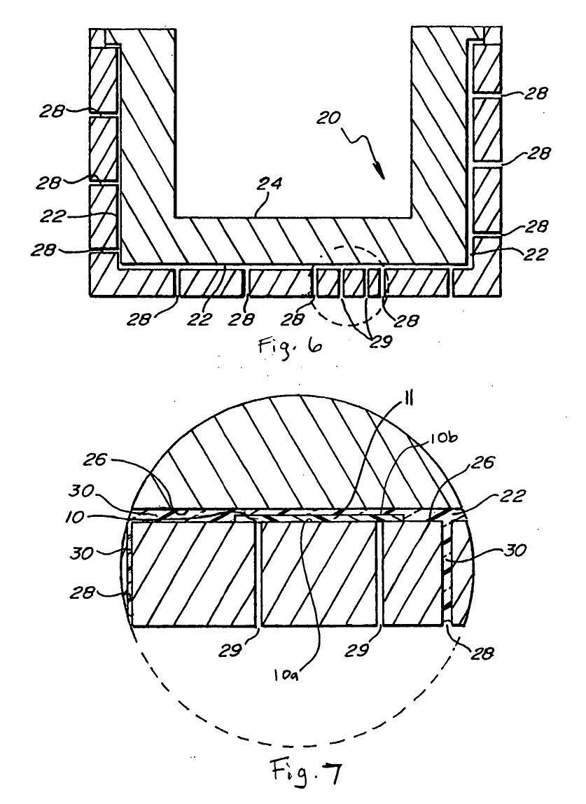

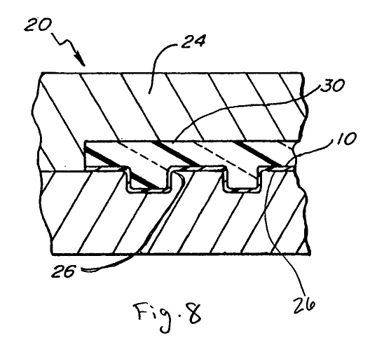

Referring to FIGS. 1-8, the present invention includes insert molding an RFID tag film laminate 10, having an RFID tag 11 encapsulated therein, to a selected target surface of a sensitive component handling device 12 utilizing a molding unit 20.

RFID Tag Laminate

Referring primarily to FIGS. 1-5c, The RFID tag laminate 10 generally includes two thin flexible thermoplastic polymer film layers 10a, 10b and the RFID tag 11. The films generally include at least two films 10a, 10b which are at least partially defined by a limited level of thickness. For instance, a single film layer thickness equal to or less than approximately 0.040 inches (ten-thousandths) is envisioned in one embodiment. In other embodiments, the films 10a, 10b can be less than or equal to approximately 0.020 inches (twenty-thousandths). In still further embodiments, either or both of the film layers 10a, 10b can be constructed or formed of multi-layer film laminates. Of course, the implementation of such multi-layer laminates to define one or both of the films 10a, 10b will alter the thickness criteria described hereinabove. It should be noted that various figures depict the laminate 10, and corresponding films 10a, 10b, as disproportionately large in comparison to the corresponding handling devices 12 or parts 32 for illustrative purposes only and are not intended to represent actual dimensions or proportions for the present invention.

Any compatible material can be utilized for the films 10a, 10b, with at least one of the films having minimal protective characteristics that can provide barrier protection against the heat generated during the molding process, to protect the RFID tag 11. In one embodiment, the laminate 10 must be capable of withstanding temperatures of approximately 600° F. For example, polyester, PE, PC, PP, polyimide (PI), polyether imide (PEI), PEEK, perfluoroalkoxy resin (PFA), fluorinated ethylene propylene copolymer (FEP), polyvinylidene fluoride (PVDF), polymethyl methacrylate (PMMA), polyether sulfone (PES), polystyrene (PS), polyphenylene sulfide (PPS), and a myriad of other compatible polymers are available for implementation with the present invention. In at least one embodiment, the material selection for at least one of the films 10a, 10b will be PC. Other embodiments may utilize PP, PEEK, and PEI for the film layers 10a, 10b, or combinations thereof. For illustrative purposes, film 10b will be generally designated as the film layer providing contact with the molten material resin in the molding processes described herein.

The RFID tag 11 can be those utilized and known to one skilled in the art. In one embodiment, the RFID tag 11 includes a flexible circuit and circuit components such as that manufactured and sold under the TI Tag-it HF-I, RI-103-112A, product identifier. Such an RFID tag 11 can have an operating temperature of −25° C. to +70° C., a base PET substrate material, a 0.3555 mm chip thickness, and support for the ISO 15693-2, -3 standard. As stated, other compatible RFID tags known to those skilled in the art can also be employed without deviating from the spirit and scope of the present invention.

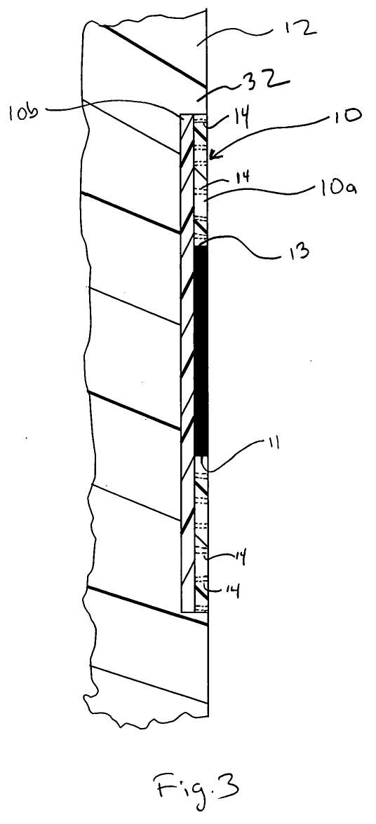

The RFID tag 11 can bonded between the film layers 10a, 10b utilizing accepted and compatible adhesives, or with other accepted techniques of laminate construction or bonding. Further, in one embodiment, at least one of the films 10a, 10b, and preferably 10a, can include a recess 13 or thermoformed indentation sized and shaped to receive the RFID tag therein, as shown in FIG. 3.

To create channels or escape passageways 14 to permit air and other gasses to escape from between the film layers 10a, 10b of the laminate 10, holes and/or perforation patterns or areas can be provided in at least one of the layers, i.e., film 10a, as demonstrated in FIG. 3. These passageways or channels in the laminate 10 facilitate evacuation of air pockets or trappings within the layers of the laminate 10 resulting from the environmental conditions, such as heat, that are created when the laminate 10 is bonded to the device 12. In various embodiments, channels can be created between the laminate 10 films 10a, 10b by selective application of the adhesive described herein to bond the films 10a, 10b and the RFID tag 11. For instance, lines of adhesives can be selectively placed across the interior confronting faces of the films 10a, 10b during creation or construction of the laminate 10 such that one or more non-adhesive channels or gaps are created across the width and/or length of the interior area of the laminate 10 to provide these escape channels. Other methods and techniques for facilitating the evacuation of gas pockets or air traps from within the laminate 10 known to one of ordinary skill in the art can be employed without deviating from the spirit and scope of the present invention.

In various embodiments, at least one of the films 10a, 10b, and preferably 10a, can include graphical indicia such as product identifiers, company logos, textual instructions, and the like. Selective bonding of this laminate 10 having graphical indicia to the target surface of the handling device 12 can further enhance aesthetic appeal for the device 12 and serve to visually block the encased or encapsulated RFID tag 11 from the user's line of sight.

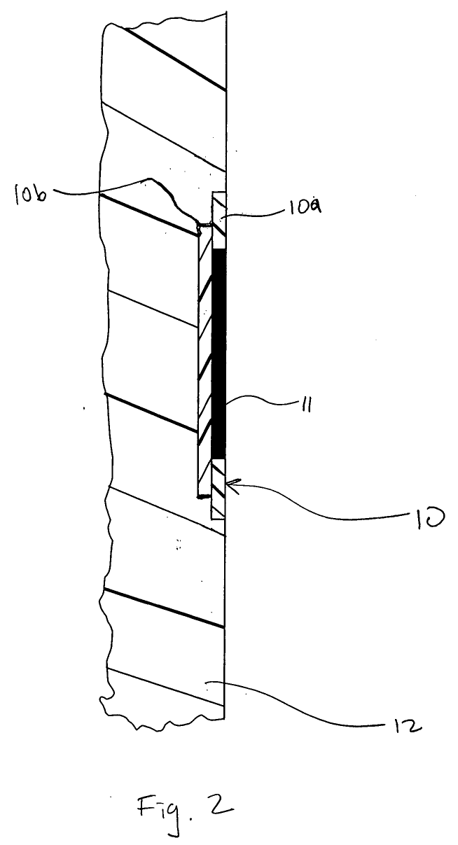

To employ the laminate 10 in manufacturing of sensitive component handling devices 12, the films 10a, 10b are generally cut to a predetermined shape and size depending on the particular needs of the bonding application. In one embodiment, the films 10a, 10b are of substantially identical dimensions. Various other embodiments will utilize films 10a, 10b of differing size, with film 10b preferably being at least large enough to protectively cover the sensitive components of the encapsulated RFID tag 11, as shown in FIG. 2.

As referenced herein, each of the films 10a, 10b can be constructed of various film layers to further create a film laminate for each of the respective films 10a, 10b. Such film laminates for the films 10a, 10b can be employed to provide additional preferred characteristics in the film laminate, such as those understood to add abrasion resistance, chemical resistance, temperature resistance, absorption barriers, outgassing barriers, and like characteristics to the portion or surface of the handling device 12 moldably receiving the film laminate 10. A myriad of film lamination techniques known to one skilled in the film lamination art are envisioned for use with the present invention. For instance, U.S. Pat. Nos. 3,660,200, 4,605,591, 5,194,327, 5,344,703, and 5,811,197 disclose thermoplastic lamination techniques and are incorporated herein by reference.

RFID Tag Film Insert Molding

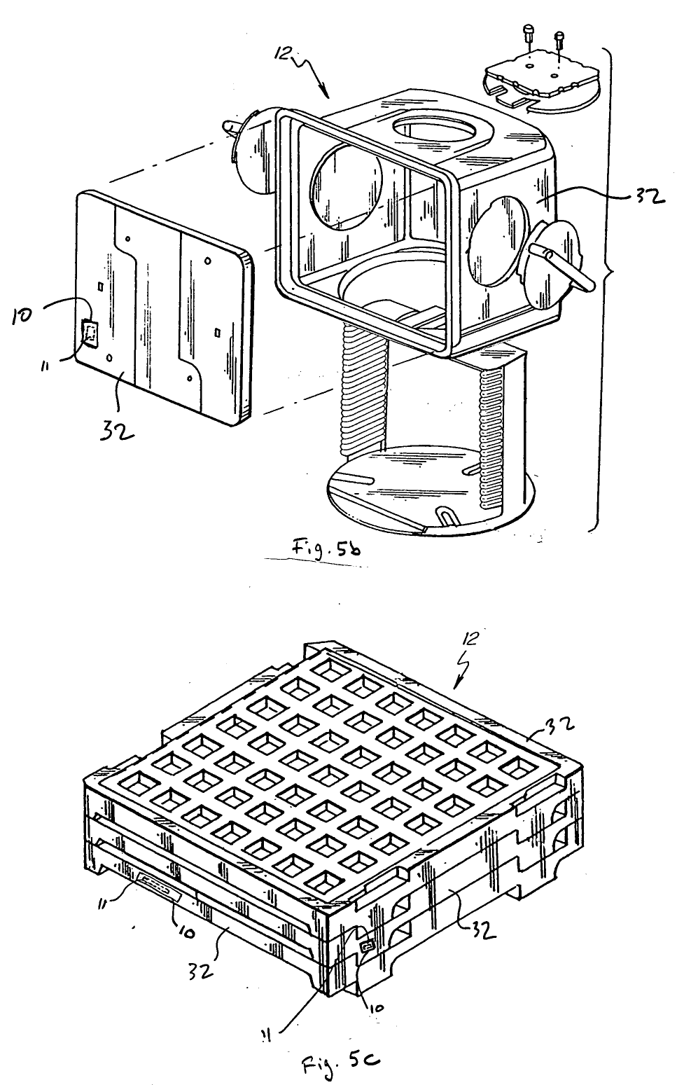

Referring primarily to FIGS. 6-8, in one embodiment, the molding unit 20 implemented in molding the RFID film laminate 10 to the device 12 generally includes a mold cavity 22, a cover portion 24, and at least one injection channel portion 28. The at least one injection channel 28 is in fluid communication with the mold cavity 22. The mold cavity 22 can include a shaping surface 26, or surfaces, designed to shape the injected moldable material 30 and/or the RFID tag laminate 10 during the molding process. The cover portion 24 selectively engages or covers the mold cavity 22. Various embodiments of the molding unit 20 can further include at least one vacuum channel 29 in communication with the mold cavity 22 and/or the shaping surface 26 to introduce vacuum suction in securing an object, such as the laminate 10, to the mold cavity 22. Other known techniques for securably conforming the lamiante 10 within the cavity 22 and shaping surface 26 employing static securement and forceable engagement are also envisioned for use with the present invention. As stated, the films and laminates depicted in the figures are enlarged for illustrative purposes and are not necessarily representative of the dimensions (i.e., thickness) and proportionality of the invention.

In one embodiment, the cover portion 24 is removably securable to the mold cavity 22 to facilitate insertion of the RFID tag laminate 10, and removal of the finished handling device portion or part 32. The molded part 32 is generally something less than a completed handling device 12, but in alternative embodiments a complete handling device 12 can be molded in a single process, with a single molding unit 20. For instance, it is common for sidewall inserts and shelves of wafer carriers to be separately molded, and often to be molded of dissimilar plastics in comparison to the main body of the carrier. Various injection and insert molding techniques known to those skilled in the art and can be implemented without deviating from the spirit or scope of the present invention.

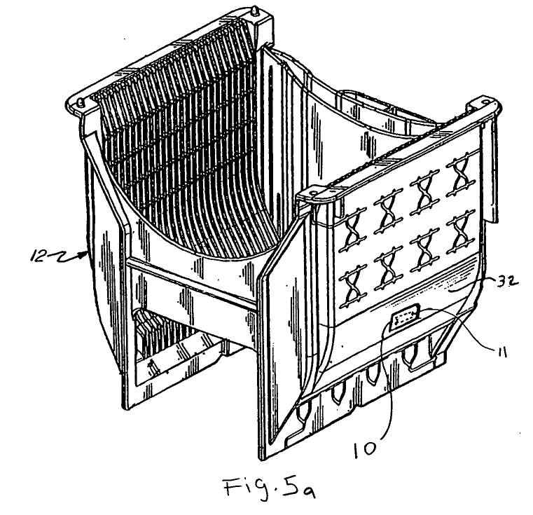

The moldable material 30 is preferably a substantially non-conductive thermoplastic material commonly used in molding parts used in the semiconductor processing and handling industry. Again, the material 30 can be PFA, PE, PC, and the like. More specifically, the moldable material 30 can be the material conventionally used to construct wafer carriers (FIGS. 5a-5b), chip trays (FIG. 5c), hard disk handlers, and other sensitive component handling devices and parts thereof.

In operation, the RFID tag laminate 10 is generally placed into the molding unit 20 such that the laminate 10, and film 10a in particular, is in surface contact with at least a portion of the at least one shaping surface 26 of the mold cavity 22. As indicated herein, various techniques such as vacuum, static, and forceable securement can be implemented to facilitate proper positioning of the laminate 10 to the cavity 22 or the shaping surface 26. The cover portion 24 may then be closed in preparation for injection of the material 30. At this stage of the process, the moldable resin material 30 is injected in a generally molten state into the cavity through the at least one injection channel 28. The moldable molten resin material 30 comes into contact with the film layer 10b of the laminate 10 such that the RFID tag 11 and its corresponding componentry are protected from the high temperatures. After waiting a desired cooling period, the moldable material 30 within the molding unit 20 cools to form the substantially solidified molded part 32 or handling device 12. The molten injection combined with the cooling process forms a permanent adhering bond between the laminate 10, and film 10b in particular, and the molded part 32.

After completion of the molding process, the molded part 32 can be ejected from the molding unit 20 with the part 32 or device 12 having the RFID tag laminate 10 permanently bonded to a selective target surface thereon. Conventional tooling, techniques, and practices known by those skilled in the art can be used in injecting the material 30 and ejecting the part 32.

In certain instances, the insert molded RFID tag laminate 10 may not adhere sufficiently to other polymers, such as those used in constructing various handling devices 12. For example, PEEK does not adhere in all cases to overmolded PC. As such, an intermediate film, or tie layer, can be included on any surface of either of the films 10a, 10b to facilitate bonding. For example materials such as PEI can adhere to both the PEEK and PC material. Other materials can be utilized as well to promote adhesion and the applicable molding processes.

With such selective bonding of the RFID tag laminate 10, the RFID tag 11 can be selectively applied to almost any target surface of the respective handling device 12. While various embodiments are directed to integrally bonding the RFID laminate 10 to the outer surface of the handling device 12, a myriad of other interior and component surfaces can be selectively targeted for bonding with the laminate 10 without deviating from the spirit and scope of the invention. As such, manufacturing costs and contamination can be minimized while simultaneously enhancing functional performance and aesthetic appeal for the handling devices 12. Further, material construction of and component complexity for the handling devices 12 need not be jeopardized to include the benefits of an RFID tag system.

The present invention may be embodied in other specific forms without departing from the spirit or essential attributes thereof, and it is, therefore, desired that the present embodiments be considered in all respects as illustrative and not restrictive.

1. A wafer container having a Radio Frequency Identification (“RFID”) tag integrated therein, comprising:
an enclosure portion made from thermoplastic polymer material and adapted for holding at least one wafer; and
an RFID film laminate member integrally molded in a surface of the enclosure portion by way of film insert molding, the RFID film member including a first thin flexible film layer, a second thin flexible film layer, and an RFID tag encapsulated between the first and second thin flexible film layers, and wherein the first thin flexible film layer provides a barrier layer between the RFID tag and the enclosure portion during the film insert molding.

2. The wafer container of claim 1, wherein at least one of the first and second thin flexible film layers is less than or equal to approximately 0.020 inches.

3. The wafer container of claim 1, wherein the RFID tag is encapsulated between the first and second thin flexible film layers with an adhesive.

4. The wafer container of claim 1, wherein at least one of the first and second thin flexible film layers includes a recess adapted to receive the RFID tag therein.

5. The wafer container of claim 1, wherein at least one of the first and second thin flexible film layers includes a thermoformed indentation adapted to receive the RFID tag therein.

6. The wafer container of claim 1, wherein at least one of the first and second thin flexible film layers is constructed of a multi-layer thin flexible film laminate.

7. The wafer container of claim 6, wherein the multi-layer thin flexible film laminate comprises a first film layer and a second film layer, with each layer being substantially constructed of a different thermoplastic polymer.

8. The wafer container of claim 1, wherein at least one of the first and second thin flexible film layers of the RFID laminate member further includes indicia marked thereon.

9. The wafer container of claim 8, wherein the indicia is marked on the second thin flexible film layer.

10. The wafer container of claim 8, wherein the indicia is graphical indicia that generally visually covers the RFID tag encapsulated within the RFID laminate member.

11. The wafer container of claim 1, wherein the first and second thin flexible film layers are generally the same size and shape.

12. The wafer container of claim 1, wherein the first and second thin flexible film layers are generally of different size and shape.

13. The wafer container of claim 1, wherein at least one of the first and second thin flexible film layers is constructed substantially of a material selected from the group consisting of: polyester, polypropylene, polyimide, polyether imide, polyetheretherketone, perfluoroalkoxy resin, fluorinated ethylene propylene copolymer, polyvinyldiene fluoride, polymethyl methacrylate, polyether sulfone, polystyrene, and polyphenylene sulfide.

14. The wafer container of claim 1, wherein at least one of the first and second thin flexible film layers includes at least one perforation therein to provide a gas evacuation channel therethrough.

15. A method of making a wafer container having a Radio Frequency Identification (“RFID”) tag integrated therein, the method comprising the steps of:
forming an RFID film laminate member from a first thin flexible film layer, a second thin flexible film layer, and an RFID tag encapsulated between the first and second thin flexible film layers;
positioning the RFID film laminate member on a shaping surface of a mold such that the second thin flexible film layer is confronting the shaping surface; and
molding thermoplastic polymer material over the shaping surface of the mold to form an enclosure portion of the wafer container, the RFID film laminate member being thereby integrally bonded in the enclosure portion, with the first thin flexible film layer serving as a protective barrier from the thermoplastic polymer material during molding.

16. The method of claim 15, wherein forming the RFID film laminate member includes providing graphical indicia on at least one of the first and second thin flexible film layers.

17. The method of claim 15, wherein forming the RFID film laminate member includes providing at least one perforation in at least one of the first and second thin flexible film layers to provide a gas evacuation channel during molding.

18. A chip handling tray having a Radio Frequency Identification (“RFID”) tag integrated therein, comprising:
a tray portion made from thermoplastic polymer material; and
an RFID film laminate member integrally molded in a surface of the tray portion by way of film insert molding, the RFID film member including a first thin flexible film layer, a second thin flexible film layer, and an RFID tag encapsulated between the first and second thin flexible film layers, and wherein the first thin flexible film layer provides a barrier layer between the RFID tag and the tray portion during the film insert molding.

19. The chip handling tray of claim 18, wherein at least one of the first and second thin flexible film layers is less than or equal to approximately 0.020 inches.

20. The chip handling tray of claim 18, wherein the RFID tag is encapsulated between the first and second thin flexible film layers with an adhesive.

21. The chip handling tray of claim 18, wherein at least one of the first and second thin flexible film layers includes a recess adapted to receive the RFID tag therein.

22. The chip handling tray of claim 18, wherein at least one of the first and second thin flexible film layers includes a thermoformed indentation adapted to receive the RFID tag therein.

23. The chip handling tray of claim 18, wherein at least one of the first and second thin flexible film layers is constructed of a multi-layer thin flexible film laminate.

24. The chip handling tray of claim 23, wherein the multi-layer thin flexible film laminate comprises a first film layer and a second film layer, with each layer being substantially constructed of a different thermoplastic polymer.

25. The chip handling tray of claim 18, wherein at least one of the first and second thin flexible film layers of the RFID laminate member further includes indicia marked thereon.

26. The chip handling tray of claim 25, wherein the indicia is marked on a surface of the second thin flexible film layer.

27. The chip handling tray of claim 25, wherein the indicia is graphical indicia that generally visually covers the RFID tag encapsulated within the RFID laminate member.

28. The chip handling tray of claim 18, wherein the first and second thin flexible film layers are generally the same size and shape.

29. The chip handling tray of claim 18, wherein the first and second thin flexible film layers are generally of different size and shape.

30. The chip handling tray of claim 18 wherein at least one of the first and second thin flexible film layers is constructed substantially of a material selected from the group consisting of: polyester, polypropylene, polyimide, polyether imide, polyetheretherketone, perfluoroalkoxy resin, fluorinated ethylene propylene copolymer, polyvinyldiene fluoride, polymethyl methacrylate, polyether sulfone, polystyrene, and polyphenylene sulfide.

31. The chip handling tray of claim 18, wherein at least one of the first and second thin flexible film layers includes at least one perforation therein to provide a gas evacuation channel therethrough.

32. A method of making a chip handling tray having a Radio Frequency Identification (“RFID”) tag integrated therein, the method comprising the steps of:
forming an RFID film laminate member from a first thin flexible film layer, a second thin flexible film layer, and an RFID tag encapsulated between the first and second thin flexible film layers;
positioning the RFID film laminate member on a shaping surface of a mold such that the second thin flexible film layer is confronting the shaping surface; and
molding thermoplastic polymer material over the shaping surface of the mold to form a tray portion of the chip handling tray, the RFID film laminate member being thereby integrally bonded in the tray portion, with the first thin flexible film layer serving as a protective barrier from the thermoplastic polymer material during molding.

33. A semiconductor component handling device having a Radio Frequency Identification (“RFID”) tag integrated therein, comprising:
an handler housing portion made from thermoplastic polymer material and adapted for housing at least one semiconductor component; and
an RFID film laminate member integrally molded in a surface of the handler housing portion by way of film insert molding, the RFID film member including a first thin flexible film layer, a second thin flexible film layer, and an RFID tag encapsulated between the first and second thin flexible film layers, and wherein the first thin flexible film layer provides a barrier layer between the RFID tag and the handler housing portion during the film insert molding.

34. The handling device of claim 33, wherein at least one of the first and second thin flexible film layers of the RFID laminate member further includes indicia marked thereon.

35. The handling device of claim 33, wherein at least one of the first and second thin flexible film layers includes at least one perforation therein to provide a gas evacuation channel therethrough.

36. A semiconductor component handling device having a Radio Frequency Identification (“RFID”) tag integrated therein, comprising:
means for housing at least one semiconductor component, made from thermoplastic polymer material; and
means for laminating an RFID tag being integrally molded in a surface of the means for housing by way of film insert molding such that the RFID tag is encapsulated to provide barrier protection for the RFID tag during integral bonding of the means for laminating an RFID tag to the means for housing during the film insert molding.

37. A method of film insert molding a Radio Frequency Identification (“RFID”) tag to a semiconductor component handling device, comprising the steps of:
forming an RFID tag film laminate of a first thin flexible film layer, a second thin flexible film layer, and the RFID tag encapsulated between the first and second thin flexible film layer;
accessing a molding unit having a mold cavity, the mold cavity including at least one shaping surface;
positioning the RFID tag film laminate within the cavity of the molding unit along at least a portion of the at least one shaping surface;
injecting a substantially molten thermoplastic material into the cavity of the molding unit, over the positioned RFID tag film laminate, to conform to the shape of the at least one shaping surface;
waiting a cooling period wherein the thermoplastic material substantially solidifies to matably bond with the RFID tag film laminate to create at least a portion of the component handling device; and
ejecting the at least a portion of the component handling device, with the RFID tag film laminate integrated thereto, from the molding unit.

38. The method of claim 37, wherein forming the RFID film laminate includes providing graphical indicia on at least one of the first and second thin flexible film layers.

39. The method of claim 37, wherein forming the RFID film laminate includes providing at least one perforation in at least one of the first and second thin flexible film layers to provide a gas evacuation channel during molding.
